(19) United States
(12) Patent Application Publication
(10) Pub. No.: US 2016/0261155 A1
(43) Pub. Date: Sep. 8, 2016

(54) INDUCED POLARIZATION BLDC MOTOR

(71) Applicant: I Soo LEE, Seoul (KR)

(72) Inventor: I Soo Lee, Seoul (KR)

(21) Appl. No.: 15/032,540

(22) PCT Filed: Oct. 28, 2014
(86) PCT No.: PCT/KR2014/010156

§ 371 Date: Apr. 27, 2016

(30) Foreign Application Priority Data
Oct. 28, 2013 (KR) 10-2013-0128658

(51) Int. Cl. H02K 1/27; H02K 47/20; H02K 11/22

(52) U.S. Cl. CPC H02K 1/2773; H02K 11/22; H02K 47/20; H02K 53/00

(57) ABSTRACT

The present invention relates to a BLDC motor which maximizes efficiency by induced polarization and, more particularly, to an induced polarization BLDC motor which subjects the magnetic field plane of a stator to induced polarization so as to double the magneto-motive force (active energy) thereof, and subjects the magnetic field plane of a rotor to magnetic flux concentration, so as to double the magnetic force (passive energy) thereof, thereby maximizing the torque and efficiency of a motor where two energies are synthesized. The stator comprises 2n winding slots and 2n induced polarization slits on a silicon steel sheet stacked core, and only n slots have distributed winding in independent and multiple phases. The rotor comprises planar magnets, of which both surfaces are magnetized, radially embedded on the silicon steel sheet stacked core. A commutation encoder, which is cup-shaped, is divided into a sensing region and a non-sensing region, and is installed on the outside of one side of a shaft. Two optical sensors are installed in each phase, and are connected to an H-bridge of each phase so as to form a circuit. A switching stage is formed by installing one H-bridge in each phase. Thus, in the case of applying a direct current to the motor, each phase is independently switched and the motor is started and rotated, wherein the rotation direction of the motor is determined by Fleming's left hand rule.

### TECHNICAL FIELD

The present invention relates to a BLDC motor which maximizes efficiency by induced polarization and, more particularly, to an induced polarization BLDC motor which subjects the magnetic field plane of a stator to induced polarization so as to double the magneto-motive force (active energy) thereof, and subjects the magnetic field plane of a rotor to magnetic flux concentration so as to double the magnetic force (passive energy) thereof, thereby maximizing the torque and efficiency of a motor where two energies are synthesized.

### BACKGROUND ART

A global project which physics of 21^{st} century is to solve includes an “energy issue” and a “climatic change issue”. A core project of the issues is an electric vehicle technology.

The electric vehicle is dependent on traction motor and battery technologies. An innovative new motor will need to be developed and a running costs free motor-generator will need to be born.

A robot technology which is a next-generation convergence technology targets realization of “a war in which human blood is shed by emergence of a battle robot”. Two among 3 element technologies (IT technology, motor technology, and battery technology) of a robot are causes that the new motor and the new motor-generator need to be born.

In technological innovation of a machine tool which does not use cutting oil, a high-speed motor of 60,000 RPM or more needs to be developed.

In technological innovation of an industrial machine, a high-functional and high-performance motor is required.

As an element technology that will support high function and high performance throughout respective fields including home appliances, an automobile electronic component, an electronic toy, a medical health apparatus which responds to an aging era, and the like, development of a small precision motor is required.

Three-fourths of the earth is sea. Development of an immersible motor is required for developing a submarine resource.

As the element technology of the motor, developing Neodymium Magnet (Nd₁Fe₁₄B₁) that generates 14.500 Gauss establishes the way for high horse power of a BLDC motor.
(Patent Document 1) U.S. Pat. No. 6,710,581 B1

### DISCLOSURE

### Technical Problem

In general, a BLDC motor is limited in terms of cost and manufacturing of a surface on which a semi-permanent rotor is installed, cost of a controller is high, and constant-power is not achieved.

Meanwhile, as a small motor, the BLDC motor is generally widely used, but problems including non-uniform rotation, torque-ripple, heating, and the like have not been completely solved.

The applicant has solved the problems in a prior art document (U.S. Pat. No. 6,710,581 B1) and the present invention has been made in an effort to provide an induced polarization BLDC motor which maximizes magneto-motive force (active energy) of a rotor and magnetic force (passive energy) of a rotor so as to maximize the torque and efficiency of a motor where two energies are synthesized.

### Technical Solution

In order to achieve the object, the present invention provides an induced polarization BLDC motor.

A stator includes 2n winding slots formed on a core stacked with silicon steel sheets and 2n induced polarization slits formed between the respective slots and n slots among 2n winding slots have distributed winding in independent and multiple phases, the number of phases and the number of poles are determined base on the number of phases; 2, 3, 4, . . . , n phases, the number of poles; 2, 4, 6, 8, . . . , 2n poles, coils of the respective phases are connected to an H-bridge of a switching stage for each phase to allow each phase to be independently bipolar-switched and when a winding coil is conducted, both magnetic planes of the winding slot rotates the rotor by induced polarization of an induced polarization slit.

A rotor includes planar magnets, of which both surfaces are magnetized, radially embedded on the core stacked with the silicon steel sheet so that the same poles face each other and the number of poles of the rotor is equivalent to that of the stator, and in this case, a flux density of the magnetic plane of the rotor is increased by increasing an area of the magnetic plane of the permanent magnet as possible and differential permeability is constructed to thereby subject the magnetic plane of the rotor to the magnetic flux concentration. In the rotor, a dove tail type non-magnetic holding core is configured to be installed so as to prevent magnets from being scattered during high-speed rotation without a separate mechanical device and a weight of the rotor is configured to decrease by an empty space is configured between the magnets.

A communication encoder, which is cup-shaped, is installed on one side of a rotor shaft and is divided into a sensing region and a non-sensing region, a distance (angle) of the sensing region is determined, when n; total phase, 1, 2, 3, . . . , a; excited phases, 1, 2, 3, . . . , b; in-excited phases based on 2π/(the number of poles in the rotor)}×{(n−b)phases/(the number of phases)} (degrees), and the number of sensing regions is determined based on (the number of poles)/2.

An optical sensor is configured to have two sensors disposed on each one shape to operate to correspond to the commutation encoder and when each sensor is configured to be disposed on a PCB according to a predetermined mechanical angle, two sensors of each one phase are disposed and configured to be positioned on different magnetic poles of the rotor, respectively, a layout interval of the sensors is based on {2π/(the number of poles in the rotor)}×{1/(the number of phases)} (degrees), when the optical sensor is positioned in the sensing region of the commutation encoder, the sensor generates a positive pulse, an das a result, the H-bridge is switched and current direction and excited width modulation is achieved.

In the switching stage, an input terminal of each H-bridge is connected to a DC power supply in parallel and an output terminal is connected to the winding coil of each phase, and a base of each half H-bridge of each H-bridge is connected to each optical sensor of each phase to constitute a circuit and when the motor is conducted with direct current, each H-bridge generates a part square wave to provide alternated current to each coil, and as result, the motor starts and rotates.

Further, in the induced polarization BLDC motor of the present invention, the distance (angle) of the sensing region is subjected to excited width modulation with n>b>1 [n; the number of poles, b; In-excited Phases] to be subjected to advance commutation. Therefore, the motor becomes constant power by removing hysteresis loss and the efficiency of the motor is improved.

Further, in the induced polarization BLDC motor of the present invention, in the stator, 2n winding slots have distributed winding in independent and multiple phases to allow some windings to serve as the motor and the residual windings to serve as a generator, and as a result, the motor and the generator may be integrally configured.

### Advantageous Effects

The induced polarization BLDC motor (hereinafter, referred to as ‘IP BLDC motor’) provides the following effects.

1. In the present invention, since a stator of an IP BLDC motor has no inter connection, automatic winding and automatic production are available.

2. In the present invention, a rotor of the IP BLDC motor has a simple configuration as an assembly type of a permanent magnet to be automatically produced.

3. In the present invention, a controller of the IP BLDC motor is simple in configuration, high in safety, and small in manufacturing cost.

4. In the present invention, the IP BLDC motor is easily manufactured to have large horse power.

5. In the present invention, since the IP BLDC motor is configured with independent multiple phases, the IP BLDC motor becomes a large horse power motor.

6. In the present invention, the IP BLDC motor is easily manufactured as an immersible motor.

7. In the present invention, the IP BLDC motor has no heat, noise, and vibration.

8. In the present invention, the IP BLDC motor has no Eddy current loss.

9. In the present invention, the IP BLDC motor has no Hysteresis loss.

10. In the present invention, the IP BLDC motor has no Back EMF.

11. In the present invention, the IP BLDC motor is a constant power motor in all shift intervals and in particular, has large stall torque.

12. In the present invention, the IP BLDC has efficiency of approximately 200% by an induced polarization effect of a stator, has efficiency of approximately 200% by a magnetic flux concentration effect of a rotor, and total efficiency of the motor reaches approximately 400%.

### DESCRIPTION OF DRAWINGS

FIG. 1 is a diagram illustrating an induced polarization BLDC motor of the present invention;

FIG. 2 is a diagram illustrating a sensor unit of the present invention;

FIG. 3 is a diagram illustrating a stator of a 3-phase 6-pole induced polarization BLDC motor;

FIG. 4 is a diagram illustrating a stator winding of the 3-phase 6-pole induced polarization BLDC motor;

FIG. 5 is a diagram illustrating a rotor of the 3-phase 6-pole induced polarization BLDC motor;

FIG. 6 is a diagram illustrating driving current of the 3-phase 6-pole induced polarization BLDC motor; and

FIG. 7 is a diagram illustrating output torque of the 3-phase 6-pole induced polarization BLDC motor.

### MODES OF THE INVENTION

A technical object achieved by the present invention and an embodiment of the present invention will be apparent by preferred embodiments to be described below. Hereinafter, the preferred embodiments of the present invention will be described in detail with reference to the accompanying drawings.

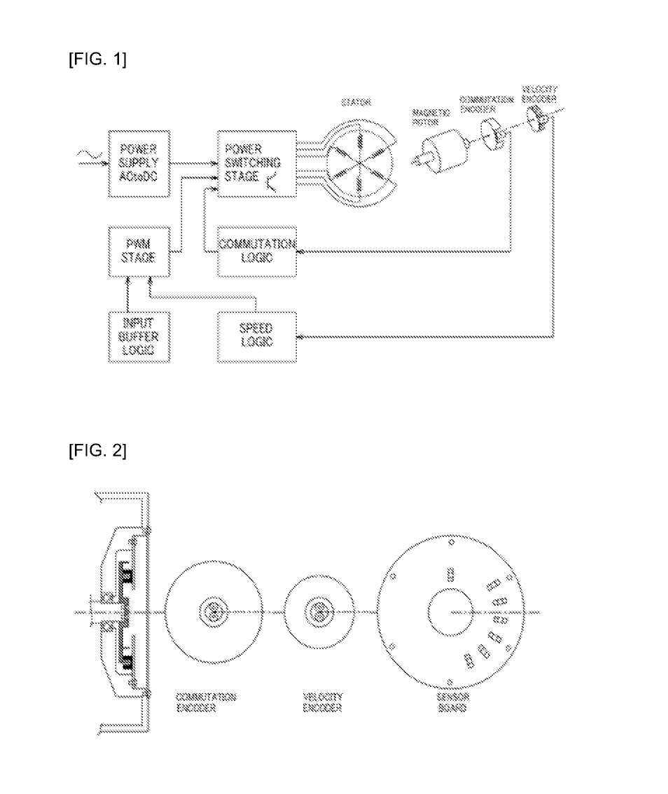

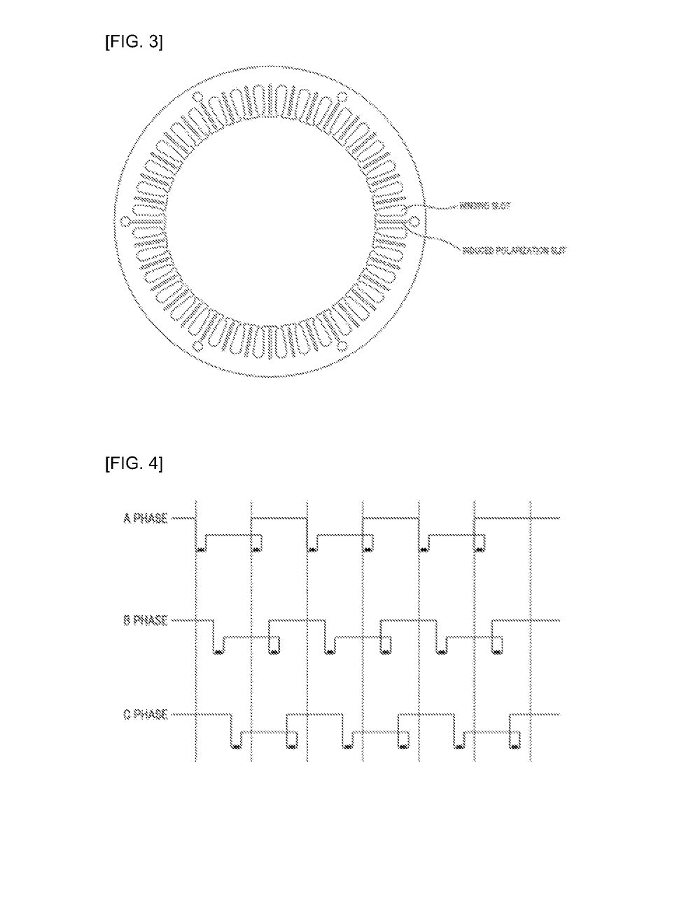

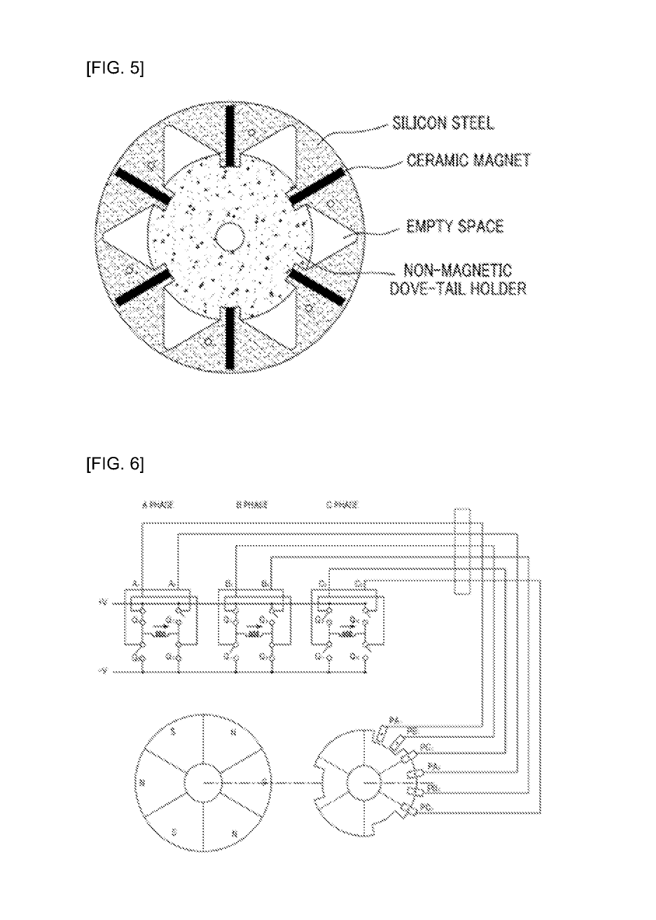

FIG. 1 is a diagram illustrating an induced polarization BLDC motor of the present invention, FIG. 2 is a diagram illustrating a sensor unit of the present invention, FIG. 3 is a diagram illustrating a stator of a 3-phase 6-pole induced polarization BLDC motor, FIG. 4 is a diagram illustrating a stator winding of the 3-phase 6-pole induced polarization BLDC motor, and FIG. 5 is a diagram illustrating a rotor of the 3-phase 6-pole induced polarization BLDC motor.

Referring to FIG. 1, an induced BLDC motor of the present invention includes a stator, a rotor, a communication encoder, a velocity encoder, a controller, and a power system and further includes a sensor board in FIG. 2.

Herein, the stator includes 2n winding slots polarization slits formed on the core stacked with silicon steel sheets and 2n induced polarization slits formed between the respective slots as illustrated in FIGS. 3 and 4. In this case, 2n induced polarization slits have a closed hole as illustrated in FIG. 3.

Further, n slots among 2n winding slots have distributed winding in independent and multiple phases. In this case, the number of phases are determined as 2, 3, 4, . . . , n phases and the number of poles is determined as 2, 4, 6, 8, . . . , 2n poles.

Coils of the respective phases are connected to an H-bridge of a switching stage for each phase to allow each phase to be independently bipolar-switched. According to the configuration, when a winding coil is conducted, both magnetic planes of the winding slot rotate the rotor by induced polarization of an induced polarization slit.

Accordingly, in the present invention, there is a cancel phenomenon and peak current is not generated, and as a result, Eddy current loss is fundamentally removed. Therefore, efficiency of the motor is improved.

Further, in the stator, 2n winding slots have distributed winding in independent and multiple phases to allow some windings to serve as the motor and the residual windings to serve as a generator, and as a result, the motor and the generator may be integrally configured.

In addition, the rotor includes planar magnets, of which both surfaces are magnetized, radially embedded on the core stacked with the silicon steel sheets so that the same poles face each other and the number of poles of the rotor is equivalent to that of the stator as illustrated in FIG. 5.

In this case, a flux density of the magnetic plane of the rotor is increased by increasing an area of the magnetic plane of the permanent magnet as possible and differential permeability is constructed to thereby subject the magnetic plane of the rotor to the magnetic flux concentration.

Further, in the rotor, a dove tail type non-magnetic holding core is configured to be installed so as to prevent magnets from being scattered during high-speed rotation without a separate mechanical device and a weight of the rotor is configured to decrease by an empty space is configured between the magnets.

The large horse power BLDC motor may be manufactured by the rotor having such a structure, and thus, a power factor and efficiency of the motor are improved.

In addition, the communication encoder, which is cup-shaped, is installed on one side of a rotor shaft and is divided into a sensing region and a non-sensing region.

In this case, a distance (angle) of the sensing region is determined, when n; total phase, 1, 2, 3, . . . , a; excited phases, 1, 2, 3, . . . , b; in-excited phases,

based on 2π/(the number of poles in the rotor)}×{(n−b)phases/(the number of phases)} (degrees), and

the number of sensing regions is determined based on (the number of poles)/2.

Further, the distance (angle) of the sensing region is subjected to excited width modulation with n>b>1 [n; the number of poles, b; In-excited Phases] to be subjected to advance commutation. Therefore, the motor becomes constant power by removing hysteresis loss and the efficiency of the motor is improved.

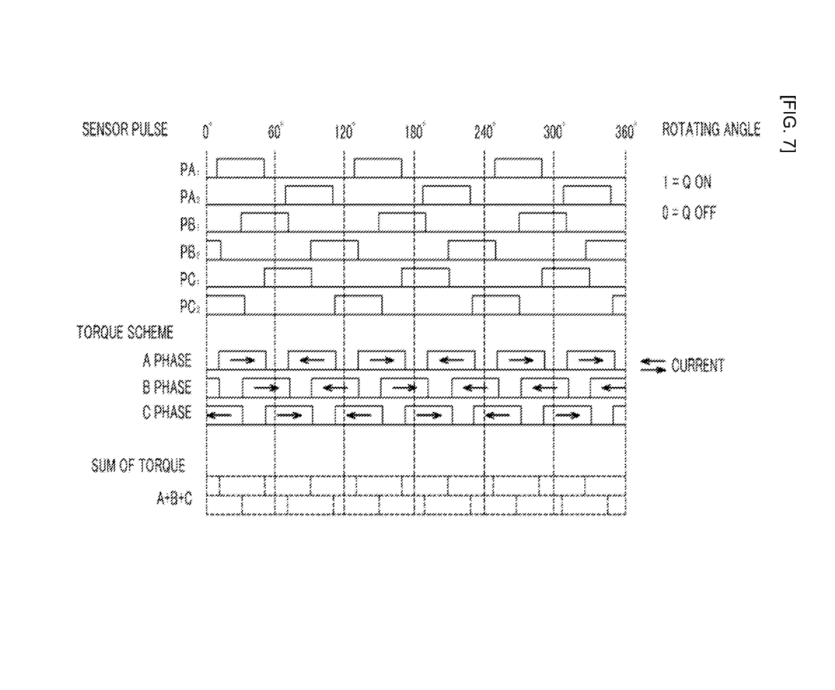

FIG. 6 is a diagram illustrating driving current of the 3-phase 6-pole induced polarization BLDC motor. FIG. 7 is a diagram illustrating output torque of the 3-phase 6-pole induced polarization BLDC motor.

As seen through the drawings, an optical sensor is configured to have two sensors disposed on each one shape to operate to correspond to the commutation encoder. Further, when each sensor is configured to be disposed on a PCB according to a predetermined mechanical angle, two sensors of each one phase are disposed and configured to be positioned on different magnetic poles of the rotor, respectively.

In this case, a layout interval of the sensors is based on {2π/(the number of poles in the rotor)}×{1/(the number of phases)} (degrees).

According to such a configuration, when the optical sensor is positioned in the sensing region of the commutation encoder, the sensor generates a positive pulse, and as a result, the H-bridge is switched and current direction and excited width modulation is achieved.

In addition, in the switching stage, an input terminal of each H-bridge is connected to a DC power supply in parallel and an output terminal is connected to the winding coil of each phase, and a base of each half H-bridge of each H-bridge is connected to each optical sensor of each phase to constitute a circuit.

According to such a configuration, when the motor is conducted with direct current, each H-bridge generates a part square wave to provide alternated current to each coil, and as result, the motor starts and rotates. In this case, a rotational direction of the motor is determined according to Fleming's left hand rule, and the motor has no torque-ripple, provides constant-power, and shows high efficiency.

Although the present invention has been described with reference to the embodiment hereinabove, it will be appreciated by those skilled in the art that various modifications and other equivalent embodiments are made therefrom.

1. An induced polarization BLDC motor, wherein:
A stator includes 2n winding slots formed on a core stacked with a silicon steel sheet and 2n induced polarization slits formed between the respective slots,
wherein n slots among 2n winding slots have distributed winding in independent and multiple phases, the number of phases and the number of poles are determined base on the number of phases; 2, 3, 4, . . . , n phases, the number of poles; 2, 4, 6, 8, . . . , 2n poles, coils of the respective phases are connected to an H-bridge of a switching stage for each phase to allow each phase to be independently bipolar-switched and when a winding coil is conducted, both magnetic planes of the winding slot rotate the rotor by induced polarization of an induced polarization slit,
a rotor includes planar magnets, of which both surfaces are magnetized, radially embedded on the core stacked with the silicon steel sheet so that the same poles face each other and the number of poles of the rotor is equivalent to that of the stator, and in this case, a flux density of the magnetic plane of the rotor is increased by increasing an area of the magnetic plane of the permanent magnet as possible and differential permeability is constructed to thereby subject the magnetic plane of the rotor to the magnetic flux concentration,
wherein in the rotor, a dove tail type non-magnetic holding core is configured to be installed so as to prevent magnets from being scattered during high-speed rotation without a separate mechanical device and a weight of the rotor is configured to decrease by an empty space is configured between the magnets,
a communication encoder, which is cup-shaped, is installed on one side of a rotor shaft and is divided into a sensing region and a non-sensing region, a distance (angle) of the sensing region is determined, when n; total phase, 1, 2, 3, . . . , a; excited phases, 1, 2, 3, . . . , b; in-excited phases based on 2π/(the number of poles in the rotor)}×{(n−b)phases/(the number of phases)} (degrees), and the number of sensing regions is determined based on (the number of poles)/2,
an optical sensor is configured to have two sensors disposed on each one shape to operate to correspond to the commutation encoder and when each sensor is configured to be disposed on a PCB according to a predetermined mechanical angle, two sensors of each one phase are disposed and configured to be positioned on different magnetic poles of the rotor, respectively, a layout interval of the sensors is based on {2π/(the number of poles in the rotor)}×{1/(the number of phases)} (degrees), when the optical sensor is positioned in the sensing region of the commutation encoder, the sensor generates a positive pulse, and as a result, the H-bridge is switched and current direction and excited width modulation is achieved,
in the switching stage, an input terminal of each H-bridge is connected to a DC power supply in parallel and an output terminal is connected to the winding coil of each phase, and a base of each half H-bridge of each H-bridge is connected to each optical sensor of each phase to constitute a circuit and when the motor is conducted with direct current, each H-bridge generates a part square wave to provide alternated current to each coil, and as result, the motor starts and rotates.

2. The induced polarization BLDC motor of claim 1, wherein the distance (angle) of the sensing region is subjected to excited width modulation with n>b>1 (n; the number of poles, b; In-excited Phases) to be subjected to advance commutation, and thus, the motor becomes constant power by removing hysteresis loss and the efficiency of the motor is improved.

3. The induced polarization BLDC motor of claim 1, wherein 2n winding slots have distributed winding in independent and multiple phases to allow some windings to serve as the motor and the residual windings to serve as a generator, and as a result, the motor and the generator may be integrally configured.
